(19) United States
(12) Patent Application Publication
(10) Pub. No.: US 2020/0238925 A1
(43) Pub. Date: Jul. 30, 2020

(54) FIXING STRUCTURE OF VEHICLE NON-ELECTRICAL WIRING MEMBER AND FIXING MEMBER

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Housei MIZUNO, Mie (JP); Shigeki IKEDA, Mie (JP); Haruka NAKANO, Mie (JP); Tetsuya NISHIMURA, Mie (JP); Masaki MIZUSHITA, Mie (JP); Takahide TSUJIMURA, Aichi (JP); Takashi SHODA, Aichi (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 16/652,466

(22) PCT Filed: Jul. 20, 2018
(86) PCT No.: PCT/JP2018/027306

§ 371 Date: Mar. 31, 2020

(30) Foreign Application Priority Data
Oct. 19, 2017 (JP) 2017-202728

(51) Int. Cl. B60R 13/02; B60H 1/00; F16B 5/00; F16B 19/00

(52) U.S. Cl. CPC B60R 13/0206; B60H 1/00564; F16B 2019/006; F16B 19/004; B60R 13/0212; F16B 5/00

(57) ABSTRACT

A fixing structure of a vehicle non-electrical wiring member includes: a plate-like member including a first layer and a second layer softer than the first layer; a vehicle non-electrical wiring member mounted on a vehicle together with the plate-like member; and a fixing member attached to the vehicle non-electrical wiring member to fix the vehicle non-electrical wiring member to the plate-like member. The fixing member includes: a through locking piece formed to be able to pass through the first layer and locked to the first layer while passing through the first layer; a regulation piece provided with a space between the regulation piece and the through locking piece to stop the through locking piece from passing through a surface of the plate-like member; and a column connecting the through locking piece and the regulation piece.

### TECHNICAL FIELD

The present invention relates to a technique of fixing a vehicle non-electrical wiring member to a mounting object,

### BACKGROUND ART

Patent Document 1 describes a technique of fixing a non-electrical wiring member such as a duct and a sound-proof sheet, which is a member mounted on a vehicle, to a mounting object, for example.

Patent Document 1 discloses that when a duct is fixed to a roof lining (also referred to as a head lining and. a roof trim, for example), the duct is fixed by an adhesive tape or an adhesive agent such as a hot-melt adhesive, and when the duct is fixed to a member which is not. the roof lining (such as a roof rail and a roof bow), the duct is mechanically fixed by a clip (also referred to as a clamp, for example).

### PRIOR ART DOCUMENTS

### Patent Documents

Patent Document 1: Japanese Patent Application Laid-Open No. 2015-151106

### SUMMARY

### Problem to be Solved by the Invention

Considered herein is the following described hereinafter as a reason why the clamp is not used when the duct is fixed to the roof lining in Patent Document 1, for example. That is to say, a hole for fixing the clamp needs to be formed in the mounting object in the fixation using the clamp. However, when the mounting object is a member exposed indoors such as the roof lining, there is a possibility that the clamp may be exposed indoors in a ease where a hole for fixing the clamp is formed in the member and the clamp is inserted into and locked to the hole. As described above, it may not be appropriate in some cases, depending on the mounting object, to apply the technique of forming the hole for fixing the clamp and fixing the clamp.

In the meanwhile, there is a possibility that the number of working processes increases when applied is a method of fixing a member to the roof lining by the adhesive tape or the adhesive agent such as the hot-melt adhesive, for example.

An object of the present invention i.s to provide a technique capable of simply fixing a vehicle non-electrical wiring member even to a mounting object which is not suitable for having a clamp hole to fix a clamp.

### Means to Solve the Problem

In order to solve the above problem, a fixing structure of a vehicle non-electrical wiring member according to a first aspect includes: a plate-like member including a first layer and a second layer and interiorly mounted on a vehicle, the second layer stacked on a first main surface of the first layer and softer than the first layer; a vehicle non-electrical wiring member fixed to the plate-like member to be mounted on a vehicle together with the plate-like member; and a fixing member mounted on the vehicle non-electrical wiring member to fix the vehicle non-electrical wiring member to the plate-like member, wherein the fixing member includes: a through locking piece in which a tip portion is formed to be able to pass through the first layer from a second main surface at an opposite side of the first layer from the first main surface and locked to the first main surface while passing through the first layer; a regulation piece provided with a space between the regulation piece and the through locking piece to stop the through locking piece from passing through a surface of the plate-like member; and a column connecting the through locking piece and the regulation piece.

The fixing structure of the vehicle non-electrical wiring member according to a second aspect is the fixing structure of the vehicle non-electrical wiring member according to the first aspect, wherein the plate-like member further includes a third layer stacked on an opposite side of the second layer from the first layer and formed harder than the second layer.

The fixing structure of the vehicle nonelectrical wiring member according to a third aspect is the fixing structure of the vehicle non electrical wiring member according to the first or second. aspect. Wherein the vehicle non-electrical wiring member includes an air-conditioning duct.

The fixing structure of the vehicle non-electrical wiring member according to a fourth aspect is the fixing structure of the vehicle non-electrical wiring member according to any one of the first to third aspects, wherein the vehicle non-electrical wiring member includes a functional sheet member stacked on the plate-like member,

The fixing structure of the vehicle nonelectrical wiring member according to a fifth aspect is the fixing structure of the vehicle non-electrical wiring member according to any one of the first to fourth aspects, wherein the fixing member includes: a first member including the through locking piece and the column, a hole formed in the column; and a second member including an insertion part which is inserted into the hole to maintain a state where the through locking piece is locked to the plate-like member.

A fixing member according to a sixth aspect is a fixing member mounted on a vehicle non-electrical. wiring member disposed on a plate-like member to fix the vehicle non-electrical wiring member to the plate-like member, the plate-like member including a first layer and a second layer, which is stacked on a first main surface of the first layer and softer than the first layer, and interiorly mounted on a vehicle. The fixing member includes: a through locking piece in which a tip portion is formed to be able to pass through the first layer from a second main surface at an opposite side of the first layer from the first main surface and locked to the first main surface while passing through the first layer; a regulation piece provided with a space between the regulation piece and the through locking piece to stop the through locking piece from passing through a surface of the plate-like member; and a column connecting the through locking piece and the regulation piece.

### Effects of the Invention

According to the first to sixth aspects, the fixing member can directly pass through the first layer in the plate-like member and be locked thereto as it is. At this time, the second layer is softer than the first layer, thus the through locking piece hardly passes through the second layer. Thus, the exposure of the through locking piece can be suppressed. As described above, the vehicle non-electrical wiring member can be simply fixed even to a mounting object which is not suitable for having a clamp hole to fix a. clamp.

When the through locking piece does not pass through the second layer, it is considered that a portion in the second layer pressed by the through locking piece is raised. Also in this case, according to the second aspect, the third layer is harder than the second layer, thus the rise in the third layer is suppressed. Accordingly, when. the third layer is located on the indoor side, the rise caused by the through locking piece is hardly specified from the indoor side. Even when the through locking piece passes through the second layer, the exposure of the through locking piece can be suppressed by the third layer. In this case, it is considered, for example, that the third layer is harder than the through locking piece, thus the passing of the through locking piece which has reached the third layer is directly suppressed, it is considered, for example, that the thickness of the third layer is larger than the length dimension of the tip portion of the through locking piece exposed from the second layer, thus suppressed is that the through locking piece passes through the third layer.

Particularly, according to the third aspect, the duct can be simply fixed even to a mounting object which is not suitable for having a clamp hole to fix a clamp.

Particularly, according to the fourth aspect, the functional sheet member can be simply fixed even to a mounting object which is not suitable for having a clamp hole to fix a clamp,

Particularly, according to the fifth aspect, the insertion part is inserted into the hole, thus easily maintained is a state where the through locking piece is locked to the plate-like member. The through locking piece can he made small in a state where the insertion part is located before a position in the hole where the locking state of the through locking piece can be maintained. Accordingly, the through locking piece can easily pass through the plate-like member.

### BRIEF DESCRIPTION OF DRAWINGS

FIG. 1 A schematic exploded perspective view illustrating a fixing structure of a vehicle non-electrical wiring member according to an embodiment and an assembling object thereof.

FIG. 2 A schematic plan view illustrating a fixing structure of the vehicle non-electrical wiring member according to the embodiment.

FIG. 3 A cross-sectional view of the vehicle non-electrical wiring member cut along a III-III line in FIG. 2.

FIG. 4 A schematic cross-sectional view illustrating a modification example of a method of attaching a fixing member to the vehicle non-electrical wiring member.

FIG. 5 A schematic perspective view illustrating a fixing member according to the embodiment.

FIG. 6 An explanation diagram illustrating the vehicle non-electrical wiring member fixed to a plate-like member using the fixing member.

FIG. 7 A schematic cross-sectional view illustrating a first modification example of the fixing member.

FIG. 8 A schematic front view illustrating a second modification example of the fixing member.

FIG. 9 An explanation diagram illustrating the fixing member according to the second modification example elastically deformed.

FIG. 10 A schematic cross-sectional view illustrating the vehicle non-electrical wiring member including the fixing member according to the second modification example.

FIG. 11 A schematic plan view illustrating a modification example of the vehicle non-electrical wiring member.

### DESCRIPTION OF EMBODIMENT(S)

### Embodiment

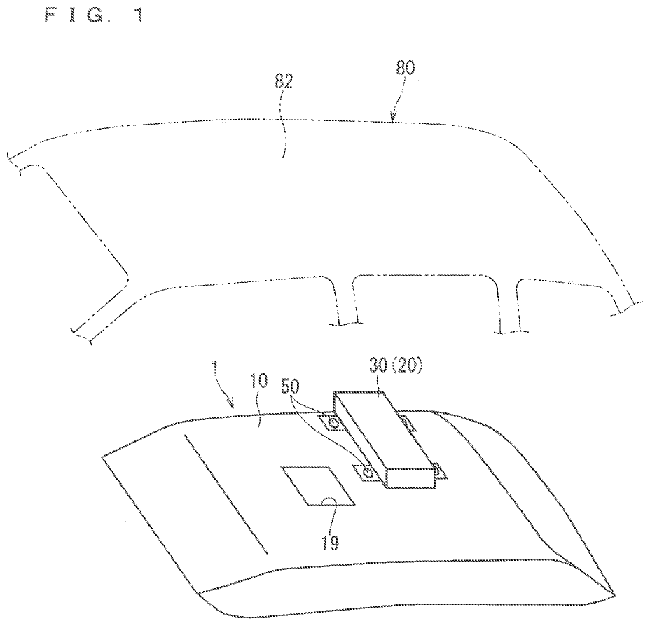

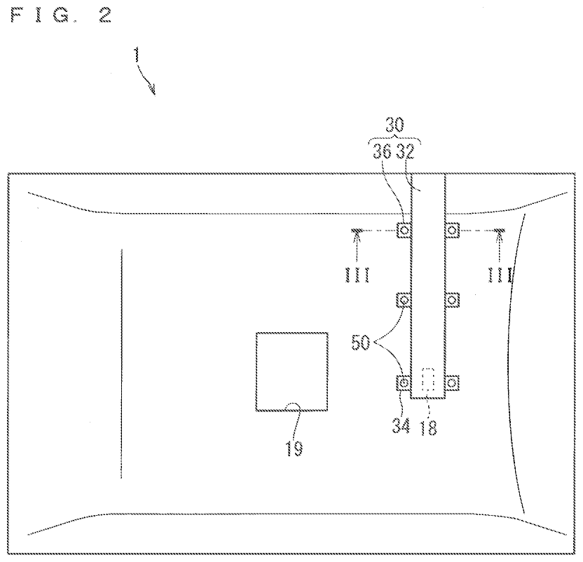

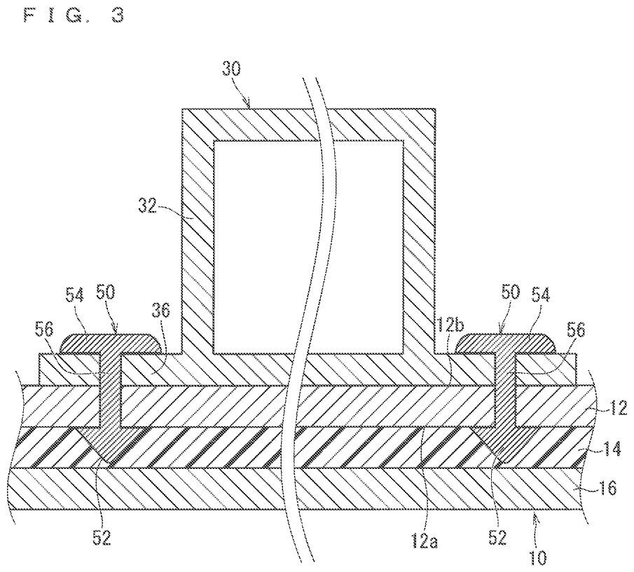

A fixing structure of a vehicle non-electrical wiring member according to an embodiment is described hereinafter. FIG. 1 is a schematic exploded perspective view illustrating a fixing structure 1 of the vehicle non-electrical wiring member according to the embodiment and an assembling object thereof. FIG. 2 is a schematic plan view illustrating the fixing structure 1 of the vehicle non-electrical wiring member according to the embodiment. FIG. 3 is a cross-sectional view of the fixing structure 1 of the vehicle non-electrical wiring member cut along a line in FIG. 1.

The fixing structure 1 of the vehicle non-electrical wiring member according to the embodiment includes a plate-like member 10, a vehicle non-electrical wiring member 20 fixed to the plate-like member 10, and a fixing member 50 for fixing the vehicle non-electrical wiring member 20 to the plate-like member 10.

The plate-like member 10 is a member interiorly mounted on a vehicle. Specifically, the plate-like member 10 includes a first layer 12 and a second layer 14. Herein, the plate-like member 10 further includes a third layer 16.

The second layer 1.4 is formed softer than the first layer 12. The third layer 16 is formed harder than the second layer 14. In comparing the first layer 12 and the third layer 16, the first layer 12 or the third layer 16 may he harder or they may have the same hardness.

The second layer 14 is stacked on a first main surface 12a of the first layer 12. The third layer 16 is stacked on an opposite side of the second layer 14 from the first layer 12. Accordingly, the first layer 12, the second layer 14, and the third layer 16 are stacked in this order. in the description hereinafter, the plate-like member 10 is interiorly mounted so that a surface of the plate-like member 10 on a side where the second layer 14 is located with respect to the first layer 12 faces an indoor side, bat may he interiorly mounted so that a surface of the plate-like member 10 on a side where the first layer 12 is located with respect to the second layer 14 faces the indoor side.

More specifically, the plate-like member 10 is described as a roof lining herein. Accordingly, the plate-like member 10 is attached to an inner surface of a ceiling part 82 in the vehicle body 80. However, it is also considered that the plate-like member 10 is the other member such as a door trim interiorly mounted on a vehicle. At this time, the fixing structure 1 of the vehicle non-electrical wiring member is preferable in a case where one surface of the plate-like member 10 is exposed indoors.

Known as such a roof lining is a roof lining including a foam resin layer for purpose of sound absorption or thermal insulation and a reinforcement layer provided on both surfaces of the foam resin layer to reinforce the foam resin layer. In the description hereinafter, in the plate-like member 10, the second layer 14 is the foam resin layer described above, and each of the first layer 12 and the third layer 16 is the reinforcement layer described above. Applicable to a resin which is a material of the foam resin layer are, for example, polyurethane series resin, polypropylene series resin, and modified polyphenylene ether series resin, for example. Considered as a configuration of the reinforcement layer is that a plate material provided separately from the foam resin layer is joined to a plate material constituting the foam resin layer. Considered in this case as the plate material constituting the reinforcement layer is, for example, a resin plate material, a plate material made of glass fiber, carbon fiber, basalt fiber, natural fiber, and organic fiber, or a non-woven cloth. A so-called skin layer is also considered as the reinforcement layer. The skin layer is a hard layer formed, at a time of forming the foam resin layer, of the same resin on the surface of the foam resin layer. Types of the first layer 12 and the third layer 16 may be the same or different from each other.

When the plate-like member 10 is the roof lining, considered is that a surface skin layer not shown in the drawings is stacked on an opposite side of the third layer 16 from the second layer 14. The surface skin layer is fanned of a material such as a non-woven cloth, a woven cloth, or a knitted cloth, for example. A main surface of the surface skin layer at an opposite side of the surface skin layer from the third layer 16 is defined as an indoor side surface of the plate-like member 10, and is exposed indoors. Also considered is that a film, for example, is stacked as a rear surface layer on an opposite side of the first layer 12 from the second layer 14. The first main surface 12a in the first layer 12 or a main surface of the rear surface layer, in the case where the rear surface layer is stacked, at an opposite side of the rear surface layer from the first layer 12 is defined as a vehicle body 80 side surface in the plate-like member 10. The indoor side surface in the plate-like member 10 is simply referred to as the front surface and the vehicle body 80 side surface in the plate-like member 10 is referred to as the rear surface in some cases hereinafter.

A thickness of each layer in the plate-like member 10 is appropriately set based on a specification required for the plate-like member 10. There may be a case herein that the plate-like member 10 partially includes a portion having a different thickness. Considered, for example, is that the plate-like member 10 formed into a flat plate-like shape once is heated and cold-pressed, thereby being partially bent and. deformed, and is molded into a desired shape. In. this case, there may be a case where a thickness of a portion bent and deformed by healing and cold-pressing is smaller than that of a portion not bent and deformed.

An opening part is formed in the plate-like member 10 which is the roof lining. Considered as the opening part are, for example, an outlet 18 of air passing through a duct 30 described hereinafter and a mounting hole 19 for locating an illuminating device.

The vehicle non-electrical wiring member 20 is a member fixed to the plate-like member 10 to be mounted on the vehicle together with the plate-like member 10, and is a. general term for the member other than an electrical wiring member. The electrical wiring member is a member for forming an electrically conducting path connecting electrical apparatuses in the vehicle, and is a member including an electrical wire such as a wire harness, for example. The duct 30 for sending the air in the vehicle is assumed as the vehicle non-electrical wiring member 20 herein. The duct 30 includes a duct body part 32 and a mounting piece 36.

The duct body part 32 is a part forming a passage of the air described above. The duct body part 32 is formed into a cylindrical shape herein. A cross-sectional shape of the duct body part 32 is not particularly limited, however, in the example illustrated in FIG. 3, a cross section is formed into a quadrangular shape, more specifically, a rectangular shape. Accordingly, the duct body part 32 includes four wall parts covering four sides of the flow path.

However, there may also be a case where the duct body part 32 is formed into a shape other than the cylindrical shape. For example, the duct body part 32 is also considered to be formed into a gutter shape, for example. In this case, an opening in the gutter-like duct body part in a circumferential direction is covered by the plate-like member 10, thus the duct body part is fixed to the plate-like member 10. That is to say, in this case, the duct body part includes three wall parts covering three sides of the flow path, and the plate-like member 10 covers the remaining one side.

The duct body part 32 is connected to an air-conditioning unit (not shown) incorporated into the vehicle. For example, the duct body part 32 is connected to the air-conditioning unit described above via a pillar duct extending to an outer side of the roof lining. The pillar duct is a part extending to a lower side of a body part 80 along a pillar, for example. At this time, air supplied inside the duct body part 32 from the air-conditioning unit is blown to an indoor side through the outlet 18 formed in the roof lining, in this case, a tip portion of the duct body part 32. is preferably formed into a shape capable of covering the outlet 18, for example, an L-like cylindrical shape.

In the example illustrated in FIG. 2, the duct body part 32 is formed to extend in a right-left direction of the vehicle, however, the extension form of the duct body part 32 is not limited thereto. For example, the duct body part 32 may be formed to be formed in an anteroposterior direction of the vehicle, or may include both a portion extending in the right-left direction of the vehicle and a portion extending in the anteroposterior direction. The duct body part 32 may be formed by joining a plurality of members along the extension direction.

The mounting piece 36 is a part to which the fixing member 50 is attached, The fixing member 50 is attached to the mounting piece 36, thus the fixing member 50 is fixed to the duct 30. Specifically, the mounting piece 36 is formed to extend to an outer side (a lateral side herein) from an external surface of the duct body part 32. The fixing member 50 passes through the mounting piece 36 while being attached to the fixing member 50. The mounting piece 36 intervenes between a regulation piece 54 described hereinafter of the fixing member 50 and the first layer 12 in a state where the duct 30 is fixed to the plate-like member 10 by the fixing member 50.

In the example illustrated in FIG. 2, the plurality of mounting pieces 36 are formed smaller in length than the duct body part 32 along the extension direction of the duct body part 32 at intervals. The fixing member 50 is attached to each of the plurality of mounting pieces 36. When the plurality of mounting pieces 36 are provided, there may be the mounting piece 36 to which the fixing member 50 is not attached. In the example illustrated in FIG. 2, the mounting piece 36 is formed to extend to both sides of the duct body part 32. However, the mounting piece 36 may include a part formed to extend to only one side from the duct body part 32. Also considered is that the plurality of mounting pieces 36 are disposed in a zigzag manner with respect to the duct 30.

The mounting piece 36 may be sequentially formed along the extension direction of the duct body part 32. Particularly, the mounting piece 36 may be formed over the whole extension direction of the duct body part 32 on the roof lining. When the mounting pieces 36 are sequentially formed along the extension direction of the duct body part 32, the fixing member 50 can be attached to an optional position with respect to the mounting pieces 36 uniformly extending along the extension direction of the duct body part 32.

In the example illustrated in FIG. 3, the fixing member 50 is located on the lateral side of the duct body part 32, however, this configuration is not necessary. For example, it is also applicable that the mounting piece 36 extends to the lower side from the duct body part 32, and the fixing member 50 is attached to the lower side of the duct body part 32.

The duct 30 is integrally molded so that the duet body part 32 and the mounting piece 36 are integral with each other by blow molding using a resin as a material.

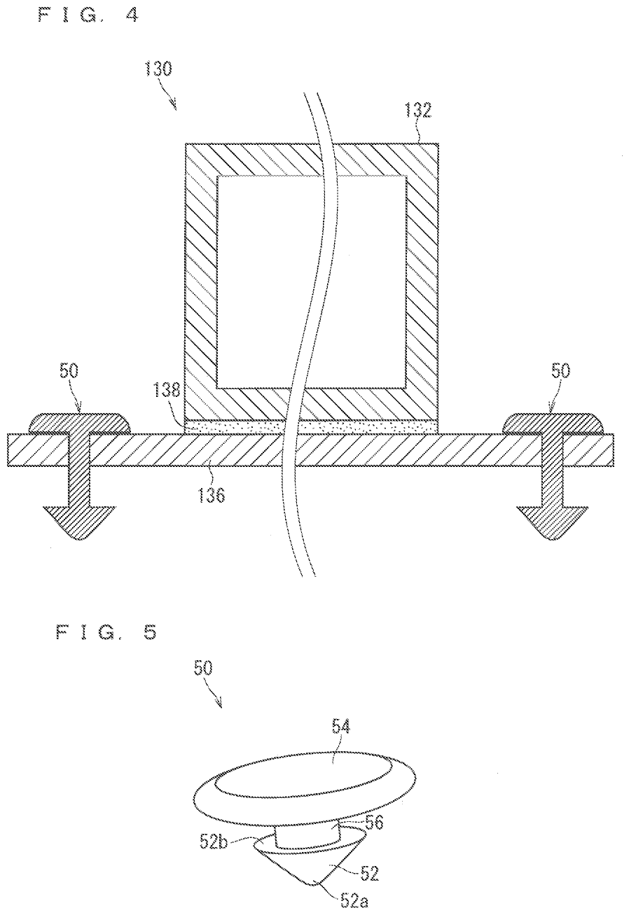

Herein, as illustrated in FIG. 4, it is also considered that a duct body part 132 and a mounting piece 136 are separately formed in a duct 130. In the example illustrated in FIG. 4, the mounting piece 136 is formed into a sheet-like shape and fixed to the duct body part 132. In the example illustrated in FIG. 4, the mounting piece 136 is bonded to the duct body part 132 by an adhesive agent 138. However, the mounting piece 136 may be fixed to the duct body part 132 by the other fixation method such as welding, a double-sided adhesive tape, a screw, and press fitting. In the example illustrated in FIG. 4, the mounting piece 136 is bonded to the lower surface of the duct body part 132, but may also be bonded to the other surface such as a side surface or an upper surface. As described above, when the duet body part 132 and the mounting piece 136 are separately formed, the fixing member 50 can be attached without changing a design of the existing duet body part 132.

FIG. 5 is a schematic perspective view illustrating the fixing member 50 according to the embodiment.

The fixing member 50 is attached to the vehicle non-electrical wiring member 20. The fixing member 50 is a member for fixing the vehicle non-electrical wiring member 20 to the plate-like member 10. Specifically, the fixing member 50 includes a through locking piece 52, the regulation piece 54, and a column 56. The fixing member 50 is formed of a resin or metal, for example, as a material. The fixing member 50 is considered an integrated molded component using molds, for example.

In the through locking piece 52, a tip portion 52a is formed to be able to pass through the first layer 12 from a second main surface 121 at an opposite side of the first layer 12 from the first main surface 12a. That is to say, the through locking piece 52 is formed to be able to pass through the plate-like member 10 from the rear surface of the plate-like member 10. The through locking piece 52 can pass through a portion in the plate-like member 10 where a hole is not formed. The through locking piece 52 is locked to the first main surface 12a while passing through the first layer 12. The through locking piece 52 is formed into a tapered shape, for example, (a cone shape herein). The through locking piece 52 is formed into the tapered shape, thus mold release can be easily performed when the fixing member 50 is integrally molded using molds, A bottom part 52b of a cone is a part connected to the column 56, and is a part locked to the first main surface 12a While passing through the first layer 12. A vertex of the cone is the tip portion 52a in the through locking piece 52.

The regulation piece 54 is provided with a space between the regulation piece 54 and the through locking piece 52. The regulation piece 54 stops the through locking piece 52 from passing through the surface of the plate-like member 10. For example, the regulation piece 54 is hooked to and locked to the second main surface 12b of the first layer 12 or the rear surface of the plate-like member 10, thereby stopping the through locking piece 52 from proceeding forward in. a passing-through direction any more,

Accordingly, any shape and size of the regulation piece 54 are applicable as long as the through locking piece 52 can be hooked to a peripheral edge of a hole formed in the first layer 12 and a layer closer to the rear surface than the first layer 12 when the through. locking piece 52 passes through the first layer 12 and the layer closer to the rear surface. Herein, the regulation piece 54 is formed into the disk shape having the same shaft center as the through locking piece 52. In this case, the regulation niece 54 is preferably formed equal to or larger than the through locking piece 52. As illustrated in FIG. 5, an outer periphery of the main surface at an opposite side of the regulation piece 54 from a surface connected to the column 56 (referred to as the bottom surface of the regulation piece 54 in some cases hereinafter) preferably has a chamfered shape as a rounded shape.

The column 56 connects the through locking piece 52 and the regulation piece 54. Herein, the column 56 is formed into a column shape (a cylindrical shape herein) thinner than the bottom part 52b of the through locking piece 52 and thinner than the regulation piece 54. A shall center of the column 56 coincides with the shaft center of the through locking piece 52 and the shaft center of the regulation piece 54. At least part of the column 56 is located in the first layer 12 in a state where the fixing member 50 is inserted into the plate-like member 10. At least part of the column 56 is located in the mounting piece 36 in a state where the fixing member 50 is attached to the mounting piece 36 in the duct 30.

When the fixing member 50 is attached to the mounting piece 36. a hole through which the fixing member 50 is inserted may be or may not be previously provided in the mounting piece 36. When the hole through which the fixing member 50 is inserted is previously provided, the hole may pass the through locking piece 52 or the regulation piece 54. When the hole is passed through by the through locking piece 52, it is considered that the hole is formed into a circular shape smaller than the bottom part 52b of the through locking piece 52, for example. For example, when the hole is passed through by the regulation piece 54, it is considered that the hole is formed into a slit-like shape having substantially the same length dimension as a diameter of the regulation piece 54. When the hole through which the fixing member 50 is inserted is not previously provided, it is considered that the through locking piece 52 is stuck into and passes through the mounting piece 36.

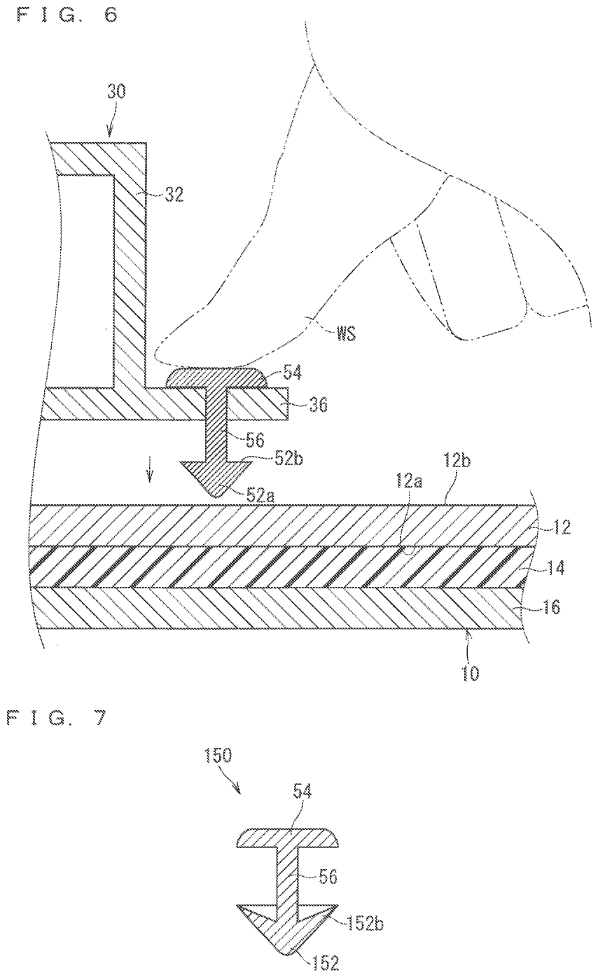

Described herein is an operation of fixing the vehicle non-electrical wiring member 20 to the plate-like member 10 using the fixing member 50. FIG. 6 is an explanation diagram illustrating the vehicle non-electrical wiring member 20 fixed to the plate-like member 10.

Firstly prepared is the vehicle non-electrical wiring member 20 to which the fixing member 50 is fixed. Prepared herein is the duct 30 in which the fixing member 50 is attached to the mounting piece 36. Then, the duct 30 is disposed in a form corresponding to an arrangement form on the plate-like member 10.

Subsequently, as illustrated in FIG. 6, the tip portion 2a of the through locking piece 52 in the fixing member 50 is directed to the rear surface of the plate-like member 10. At this time, a part of the plate-like member 10 located in front of the through locking piece 52 is a part where the hole is not previously formed. In this state, the bottom surface of the regulation piece 54 is pressed to insert the through locking piece 52 into the plate-like member 10 from the rear surface.

Then, when the regulation piece 54 is hooked to the rear surface, the plate-like member 10 via the mounting piece 36, the further pressing is stopped. Accordingly, as illustrated in. FIG. 3, the through locking piece 52 passes through the first layer 12, and the bottom part 52b of the through locking piece 52 is locked to the first main surface 12a of the first layer 12. The bottom part 52b of the through locking piece 52 may be locked to the first main surface 12a of the first layer 12 while involving a part of the second layer 14.

Herein, when the bottom part 52b of the through locking piece 52 is locked to the first main surface 12a of the first layer 12, it is considered that the through locking piece 52 can be hooked by an occurrence of at least one of a first hooking state and a second hooking state described below, for example.

Firstly, the first hooking state is as follows. That is to say, when the through locking piece 52 is inserted into the first layer 12, the through locking piece 52 is elastically deformed in a manner that a diameter of the bottom part 52b decreases under reaction force from the first layer 12. When the through locking piece 52 passes through the first layer 12 in this state, the state where the through locking piece 52 is elastically deformed is reduced by reason that the second layer 14 is softer than the first layer 12. Thus, the bottom part 521 of the through locking piece 52 extends outside the hole formed in the first layer 12 in accordance with the passing of the through locking piece 52, thus can be hooked to the peripheral edge of the hole.

The second hooking state is as follows. That is to say, when the through locking piece 52 is inserted into the first layer 12, the first layer 12 is elastically deformed to be radially spread with respect to the through locking piece 52 under force from the through locking piece 52. The hole formed in the first layer 12 in accordance with the passing of the through locking piece 52 in this state gets smaller than the bottom part 52b of the through locking piece 52 in accordance with the reduction in the elastic deformation of the first layer 12 after the passing of the through locking piece 52. Thus, the bottom part 52b of the through locking piece 52 can be hooked to the peripheral edge of the hole.

At this time, it is preferable that the through locking piece 52 can pass through the first layer 12 to such a degree that a worker can make the through locking piece 52 pass through the first layer 12 by pressing the bottom surface of the regulation piece 54 with a finger WS as illustrated in FIG. 6. The degree of passing of the through locking piece 52 through the first layer 12 is considered to be changed in accordance with a shape of the through locking piece 52, particularly a sharpness of the tip portion 52a of the through locking piece 52 and properties (hardness and elasticity) of materials constituting the through locking piece 52 and the first layer 12, for example.

It is preferable that the through locking piece 52 locked to the first main surface 12a of the first layer 12 can hardly get out of the first layer 12 to such a degree that it does not get out during use of the vehicle. The degree of difficulty that the through locking piece 52 locked to the first main surface 12a of the first layer 12 gets out of the first layer 12 is considered to be changed in accordance with a shape of the through locking piece 52, particularly a degree of extension of the bottom part 52b of the through locking piece 52 with respect to the hole formed in the first layer 12 after the through locking piece 52 has passed through the hole and a property (hardness and elasticity) of a material constituting the through locking piece 52 and the first layer 12, for example.

Herein, a sum of a length dimension of the column 56 and a height dimension of the through locking piece 52 is preferably equal to or smaller than a sum of a thickness dimension of the mounting piece 36 and a thickness dimension of the plate-like member 10, and is more preferably equal to or smaller than a sum of the thickness dimension of the mounting piece 36 and a thickness dimension from the second layer 14 to the rear surface in the plate-like member 10. Accordingly, it can be suppressed more reliably that the through locking piece 52 passes through the plate-like member 10 to be exposed out of the front surface. When the sum of the length dimension of the column 56 and the height dimension of the through locking piece 52 is larger than the sum of the thickness dimension of the mounting piece 36 and the thickness dimension of the plate-like member 10, it is considered that the third layer 16 is formed so that the fixing member 50 cannot pass through the third layer 16 for purpose of suppressing the through locking piece 52 passing through the plate-like member 10 and exposed out of the front surface.

The length dimension of the column 56 is preferably equal to or larger than a thickness dimension from the first layer 12 to the rear surface in the plate-like member 10, and is more preferably equal to or larger than a sum of the thickness dimension of the mounting piece 36 and the thickness dimension from the first layer 12 to the rear surface in the plate-like member 10. Accordingly, the through locking piece 52 can pass through the first layer 12, and the bottom part 52b of the through locking piece 52 can be hooked to the first main surface 12a of the first layer 12 more reliably.

There may be a case where one plate-like member 10 includes a portion having a different thickness as described above. Also in this case, the mounting piece 36 intervenes between the regulation piece 54 and the first layer 12, and is compressed in some cases, thus the mounting piece 36 can absorb the difference in the thickness dimension of the plate-like member 10. Accordingly, one fixing member 50 can suffice for the portion having the different thickness in the plate-like member 10.

Subsequently, all the fixing members 50 are pressed into and locked to the plate-like member 10, thus the duct 30 can be fixed to the plate-like member 10.

According to the above configuration, the fixing member 50 can directly pass through the first layer 12 in the plate-like member 10 and be locked thereto as it is. At this time, the second layer 14 is softer than the first layer 12, thus the through locking piece 52 hardly passes through the second layer 14. Thus, the exposure of the through locking piece 52 can be suppressed. In the manner described above, the vehicle non-electrical wiring member 20 (the duct 30 herein) can be simply fixed even to a mounting object which is not suitable for having a clamp hole to fix a clamp. The fixing member 50 can be previously attached to the vehicle non-electrical wiring member 20 (the duct 30 herein), the number of working processes can be reduced even in a case of fixing the vehicle non-electrical wiring member 20 (the duct 30 herein) to the plate-like member 10.

When the through locking piece 52 does not pass through the second layer 14, it is considered that a portion in the second layer 14 pressed by the through locking piece 52 is raised. Also in this case, the third layer 16 is harder than the second layer 14, thus the rise in the third layer 16 is suppressed. Accordingly, when the third layer 16 is located on the indoor side, the rise caused by the through locking piece 52 is hardly specified from the indoor side. Even when the through locking piece 52 passes through the second layer 14, the exposure of the through locking piece 52 can be suppressed by the third layer 16. In this case, it is considered, for example, that the third layer 16 is harder than the through locking piece 52, thus the passing of the through locking piece 52 which has reached the third layer 16 is directly suppressed, or the third layer 16 is harder than the first layer 12, thus the through locking piece 52 cannot pass through the third layer 16 with the force to pass through. the first layer 12. It is considered, for example, that the thickness of the third layer 16 is larger than the length dimension of the tip portion of the through locking piece 52 exposed from the second layer 14, thus suppressed is that the through locking piece 52 passes through the third layer 16.

### Modification Example

In the embodiment described above, the through locking piece 52 in the fixing member 50 has the tapered shape, however, this configuration is not necessary. For example, as is the case for a fixing member 150 illustrated in FIG. 7, a through locking piece 152 may be formed into a shape that an outer edge of a bottom part 152b protrudes toward the side of the regulation piece 54, in other words, a shape that a cone having a height lower than a cone with the bottom part 152b is removed from the side of the bottom part 152b. When the through locking piece 152 is formed into the shape illustrated in FIG. 7, the bottom part 152b can he elastically deformed easily in a direction in which a diameter decreases. The bottom part 152b can also be elastically deformed in a direction in which the diameter increases.

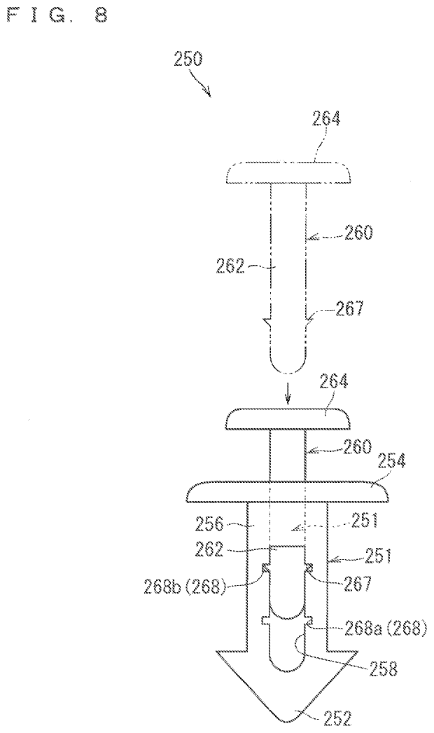

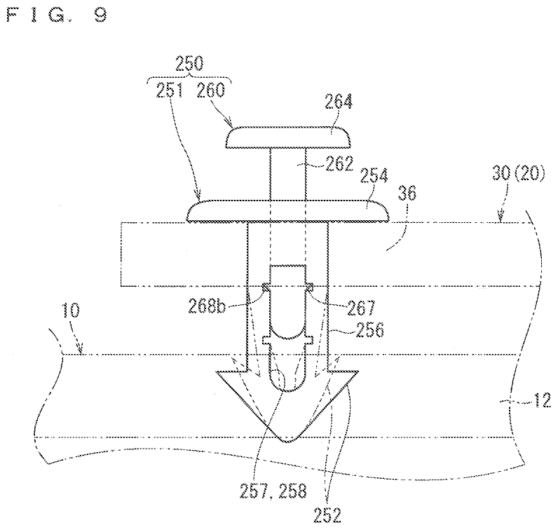

FIG. 8 is a schematic front view illustrating a second modification example of the fixing member 50. A fixing member 250 according to the second modification example is different from the fixing member 50 in that the fixing member 250 can 4; maintain a locking state of the through locking piece. Specifically, the fixing member 250 includes a first member 251 and a second member 260,

The first member 251 includes a through locking piece 252, a regulation piece 254, and a column 256. The through locking piece 252, the regulation piece 254, and the column 256 are formed into shapes similar to through locking piece 52, the regulation piece 54, and the column 56 described above, respectively (the column 256 is slightly thicker than the column 56 herein). In the first member 251, a hole 257 and a through hole 258 are formed in the column 256.

The hole 257 extends from an opening in a bottom surface of the regulation piece 254 toward the through locking piece 252. Herein, the hole 257 has a bottom, and a position of the bottom is set to a position of the through locking piece 252. However, the position of the bottom of the hole 257 may not reach the position of the through locking piece 252. It is also applicable that the hole 257 passes to a tip portion of the through locking piece 252, thus the hole 257 does not have the bottom.

The through hole 258 is formed to reach, from one position in a side surface of the column 256, an opposite position. The hole 257 and the through hole 258 communicate with each other. It is also applicable that the through locking piece 252 is not formed into the cone shape but a shape extending from the column 256 toward both lateral sides. In this case, the through locking piece may be formed in a position sandwiching the through hole 258 formed in the column 256.

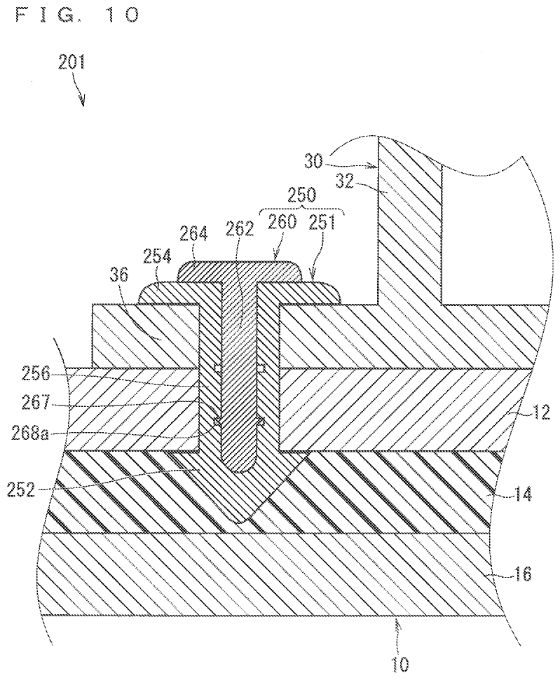

The hole 257 is formed in the first member 251, thus as illustrated in FIG. 9, a bottom part 252a of the through locking piece 252 is elastically deformed to he small easily when the through locking piece 252 passes through the plate-like member 10, The through hole 258 is formed, thus as illustrated in FIG. 9, the bottom part 252a of the through locking piece 252 is elastically deformed to be small easily when the through locking piece 252 passes through the plate-like member 10. The through hole 258 is formed, thus molds can be easily released when the first member 251 is molded using the molds at a time of forming a. concave portion 268 described hereinafter in the hole 257,

The second member 260 includes an insertion part 262 insertable into the hole 257 and an insertion regulation piece 264 preventing an excess insertion of the insertion part 262 into the hole 257.

The insertion part 262 is formed into a rod-like shape. The insertion part 262 is inserted into the hole 257, thus it can be suppressed that the through locking piece 252 in the locking state is elastically deformed to be small. Accordingly, the hole 257 and the insertion part 262 function as a maintaining part maintaining the locking state of the through locking piece 252.

It is preferable that the first member 251 and the second member 260 can be locked to each other in a state where an. insertion depth of the insertion part 262 inserted into the hole 257 is equal to a first depth. The first depth is a depth that the locking state of the through locking piece 252 locked to the plate-like member 10 can be maintained, and is a depth that the insertion part 262 reaches a back of the hole 257.

Furthermore it is more preferable that the first member 251 and the second member 260 can be locked to each other in a state where the insertion depth of the insertion part 262 inserted into the hole 257 is equal to a second depth. The second depth is set smaller than the first depth. The second depth is a depth that the insertion part 262 inserted into the hole 257 hardly prevent the elastic deformation of the through locking piece 252 when the first member 251 passes through the plate-like member 10. For example, it is considered that the vehicle non-electrical wiring member 20 having the fixing member 250 has a configuration that the first member 251 in the fixing member 250 is attached to the mounting piece 36 and the second member 260 is locked to the first member 251 in a position of the second depth. In this case, the vehicle non-electrical wiring member 20 having the fixing member 250 is transported to a vehicle assembly plant, and after the through locking piece 252 passes through the plate-like member 10 and is locked thereto, the second member 260 is further inserted into the first member 251. Then, the second member 260 is locked to the first member 251 in a position of the first depth, thereby constituting a fixing structure 201 of the vehicle non-electrical wiring member.

As the configuration that the first member 251 and the second member 260 can be locked in the state where the insertion depth of the insertion part 262 inserted into the hole 257 is the first depth and the second depth, it is considered that a protrusion 267 is formed on one of an inner peripheral surface of the hole 257 and an outer peripheral surface of the insertion part 262 and the concave portion 268 to which the protrusion 267 is locked is formed in the other one of them. Herein, the concave portion 268 is formed in the inner peripheral surface of the hole 257. The protrusion 267 is formed on the outer peripheral surface of the insertion part 262. Herein, two concave portions 268a and 268b are formed with a space therebetween along a depth direction of the hole 257.

A state where the protrusion 267 is locked to the concave portion 268a formed in a position. close to the back of the hole 257 is a state where the insertion depth of the insertion part 262 inserted into the hole 257 is the first depth. A state where the protrusion 267 is locked to the concave portion 26$b formed in a position close to an entrance of the hole 257 is a state where the insertion depth of the insertion part 262 inserted into the hole 257 is the second depth.

At this time, in the protrusion 267 and the concave portion 268, locking force acting backward in the insertion direction of the second member 260 with respect to the first member 251 is larger than locking force acting forward in the insertion direction. That is to say, the protrusion 267 and the concave portion 268 have further effect of preventing the second member 260 from getting out of the first member 251. Herein, the insertion regulation piece 264 makes up for the regulation on the second member 260 moving forward in the insertion direction with respect to the first member 251 at the first depth.

The insertion regulation piece 264 is formed into a flat plate-like shape (circular plate-like shape herein) in the manner similar to the regulation piece 254, for example. The insertion regulation piece 264 is formed smaller than the regulation piece 254 herein, but may be thrilled equal to or larger than the regulation piece 254. The insertion regulation piece 264 can be hooked into a peripheral edge of the hole 257 in the state where the insertion part 262 is inserted into the hole 257 at the first depth. Accordingly, suppressed is the further insertion of the insertion part 262 into the hole 757,

Herein, the shape of the inner peripheral surface of the hole 257 and the shape of the outer peripheral surface of the insertion part 262 are not particularly limited, thus a circular shape or a rectangular shape may also be applicable. The shape of the inner peripheral surface of the hole 257 and the shape of the outer peripheral surface of the insertion part 262 may be the same or different from each other.

The insertion part 262 may be formed equal to or larger than the hole 257. When the insertion part 262 is formed larger than the hole 257, also applicable is the configuration that the through locking piece 252 is spread by the insertion of the insertion part 262. The insertion part 262 may be formed smaller than the hole 257 as long as the insertion part 262 can maintain the locking state of the through locking piece 252 locked to the plate-like member 10.

Also considered is that the insertion part 262 and the hole 257 are formed so that a relative size thereof differs along an extension direction. It is considered in this case that, for example, the insertion part is formed equal to or smaller than the hole in a corresponding part of the insertion part and the hole between a position where the insertion part is firstly inserted into the hole and the position of the second depth, and the insertion part is formed larger than the hole in a part corresponding to a part between the second depth and the first depth. In this case, the insertion part is equal to or smaller than the hole until the insertion part reaches the position of the second depth, thus insertion force can he reduced. The insertion part is larger than the hole between the position of the second depth and the position of the first depth, thus the insertion force can he increased, and an erroneous insertion of the insertion part before being locked to the plate-like member 10 can be suppressed. A part of the insertion part larger than the hole enables the extension of the, through locking piece 252 after the insertion part is locked to the plate-like member 10.

The vehicle non-electrical wiring member 20 is preferably fixed to the plate-like member 10 in a vehicle assembly plant using the fixing member 250 described above in the following manner.

That is to say, the first member 251 in the fixing member 250 is attached to the mounting piece 36. Then, the vehicle non-electrical wiring member 20 in which the first member 251 is attached to the mounting piece 36 is transported to the vehicle assembly plant. At this time, the second member 260 is preferably transported in a state of being locked to the first member 251 in the position of the second depth as described above. However, the second member 260 may be transported in a state of not being locked to the first member 251, that is to say, transported separately from the first member 251.

Next, in the vehicle assembly plant, the first member 251 passes through the plate-like member 10 in a state where the. vehicle non-electrical wiring member 20 is disposed along the plate-like member 10. At this time, as described above, the hole 257 and the through hole 258 are formed, thus the through locking piece 252 is elastically deformed to be small easily. Thus, the first member 251 can pass through the plate-like member 10 easily.

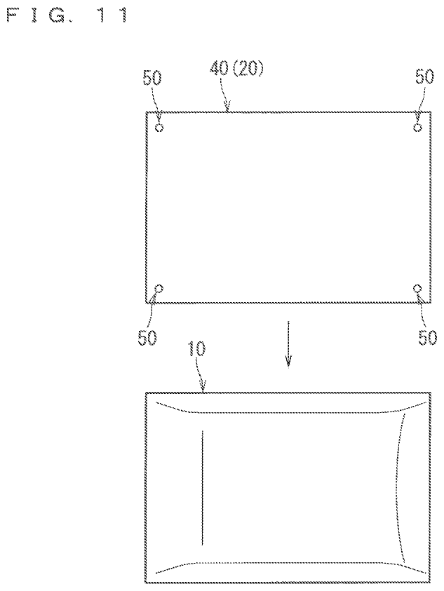

After the first member 251 passes through the plate-like member 10, the second member 260 is further inserted into the first member 251 and locked in the position of the first depth According to the above configuration, as illustrated in FIG. 10, the fixing member 250 passes through the plate-like member 10 and is locked thereto, and furthermore, the locking state is maintained.

There may be a case where the place where the fixing member 250 is attached to the vehicle non-electrical wiring member 20 and the place where the fixing member 250 is fixed to the plate-like member 10 are the same as each other In this case, there may be a case where the vehicle non-electrical wiring member 20 is fixed to the plate-like member 10 using the fixing member 250 after the vehicle non-electrical wiring member 20 to which the fixing member 250 is not attached is disposed along the plate-like member 10.

FIG. 11 is a schematic plan view illustrating a modification example of the vehicle non-electrical wiring member 20.

The above description is based on the assumption that the duct 30 is adopted as the vehicle non-electrical wiring member 20, however, a member other than the duct 30 is also considered as the vehicle non-electrical wiring member 20. In the example illustrated in FIG. 11, a functional sheet member 40 stacked on the plate-like member 10 is assumed to be adopted as the vehicle non-electrical wiring member 20.

The functional sheet member 40 is a member attached to enhance at least one of functions of sound insulating property, waterproof property, thermal insulating property, and thermal shield property of the plate-like member 10. The functional sheet member 40 is formed of a material corresponding to the function. For example, when the functional sheet member 40 has the sound insulating property, the functional sheet member 40 is formed of a non-woven cloth or a foam resin, for example. For example, when the functional sheet member 40 has the waterproof property, the functional sheet member 40 is formed of a sheet member with a uniform cross section made of an extrusion-molded resin or a sheet member whose surface is water-repellent, for example.

For example, when the functional sheet member 40 has the thermal insulating property, the functional sheet member 40 is formed of a material such as a foam resin having low thermal conductivity. For example, when the functional sheet member 40 has the thermal shield property, the functional sheet member 40 is formed of a material for an aluminum foil having a high reflectivity or a sheet member having a surface on which processing of increasing a reflectivity is performed.

In the example illustrated in FIG. 11, the functional sheet member 40 is formed to cover the entire surface of the plate-like member 10, however, the functional sheet member may cover only part of the plate-like member 10.

In the example illustrated in FIG. 11, the fixing member 50 is attached to four comers of the functional sheet member 40. The position where the fixing member 50 is attached in the functional sheet member 40 is not limited thereto described above, however, the fixing member 50 can be attached to an optical position in the functional sheet member 40.

When the functional. sheet member 40 is fixed to the plate-like member 10 using the fixing member 50, the functional sheet member 40 can be simply fixed even to a mounting object which is not suitable for having a clamp hole to fix a clamp,

Any member may be applied as the vehicle non-electrical wiring member as long as it can be fixed to the plate-like member 10, thus also considered as the vehicle non-electrical wiring member is a member other than the duct 30 described above and the functional sheet member 40 described above. Also considered as the vehicle non-electrical wiring member other than the duct 30 described above and the functional sheet member 40 described above is a pipe member such as a drain hose for discharging water pooling on a sun roof or a washer tube for supplying a washer fluid to a spray nozzle disposed near a wiper, for example. An air bag such as a curtain air-bag, or a side air-bag is also considered as the vehicle non-electrical wiring member.

There may also be a case where a plural types of member, for example, both members of the duct 30 described above and the functional sheet member 40 described. above as the vehicle non.-electrical wiring member are fixed to the plate-like member 10 by the fixing member 50.

The configurations described in the embodiments and modification examples thereof can be appropriately combined as long as they are not contradictory.

Although the present invention is described in detail, the foregoing description is in all aspects illustrative and does not restrict the invention, it is therefore understood that numerous modifications and variations can be devised without departing from the scope of the invention.

### EXPLANATION OF REFERENCE SIGNS

1 fixing structure of vehicle non-electrical wiring member

10 plate-like member

12 first layer

12a first main surface

12b second main surface

14 second layer

16 third layer

20 vehicle non-electrical wiring member

30 duct

32 duct body part

36 mounting piece

40 functional sheet member

50 fixing member

52 through locking piece

52a tip portion

52b bottom part

54 regulation piece

56 column

80 vehicle body

82 ceiling part

1. A fixing structure of a vehicle non-electrical wiring member, comprising:
a plate-like member including a first layer and a second layer and interiorly mounted on a vehicle, the second layer stacked on a first main surface of the first layer and softer than the first layer;
a vehicle non-electrical wiring member fixed to the plate-like member to be mounted on a vehicle together with the plate-like member; and
a fixing member mounted on the vehicle non-electrical wiring member to fix the vehicle non-electrical wiring member to the plate-like member, wherein
the fixing member includes:
a through locking piece in which a tip portion is formed to be able to pass through the first layer from a second main surface at an opposite side of the first layer from the first main surface and locked to the first main surface while passing through the first layer;
a regulation piece provided with a space between the regulation piece and the through locking piece to stop the through locking piece from passing through a surface of the plate-like member; and
a column connecting the through locking piece and the regulation piece.

2. The fixing structure of the vehicle non-electrical wiring member according to claim 1, wherein
the plate-like member further includes a third layer stacked on an opposite side of the second layer from the first layer and formed harder than the second layer.

3. The fixing structure of the vehicle non-electrical wiring member according to claim 1, wherein
the vehicle non-electrical wiring member includes an air-conditioning duct.

4. The fixing structure of the vehicle non-electrical wiring member according to claim 1, wherein
the vehicle non-electrical wiring member includes a functional sheet member stacked on the plate-like member.

5. The fixing structure of the vehicle non-electrical wiring member according to claim 1, wherein
the fixing member includes:
a first member including the through locking piece and the column, a hole formed in the column; and
a second member including an insertion part which is inserted into the hole to maintain a state where the through locking piece is locked to the plate-like member.

6. A fixing member mounted on a vehicle non-electrical wiring member disposed on a plate-like member to fix the vehicle non-electrical wiring member to the plate-like member, the plate-like member including a first layer and a second layer, which is stacked on a first main surface of the first layer and softer than the first layer, and interiorly mounted on a vehicle, the fixing member comprising:
a through locking piece in which a tip portion is formed to be able to pass through the first layer from a second main surface at an opposite side of the first layer from the first main surface and locked to the first main surface while passing through the first layer;
a regulation piece provided with a space between the regulation piece and the through locking piece to stop the through locking piece from passing through a surface of the plate-like member; and
a column connecting the through locking piece and the regulation piece.
